(19) United States
(12) Patent Application Publication
(10) Pub. No.: US 2011/0004894 A1
(43) Pub. Date: Jan. 6, 2011

(54) DISPLAY SERVER METHOD AND APPARATUS WITH MONITORING CAPABILITY

(75) Inventors: Thomas Patrick Newberry, Westfield, IN (US); David John Weaver, Fishers, IN (US)

Correspondence Address: Robert D. Shedd, Patent Operations;THOMSON Licensing LLC, P.O. Box 5312, Princeton, NJ, 08543-5312, US

(73) Assignee: THOMSON LICENSING

(21) Appl. No.: 12/736,142

(22) PCT Filed: Mar. 31, 2009
(86) PCT No.: PCT/US2009/001995

§ 371 Date: Sep. 14, 2010

Related U.S. Application Data
(60) Provisional application No. 61/125,587, filed on Apr. 25, 2008.

(51) Int. Cl. H04N 7/16; H04N 5/445

(52) U.S. Cl. 725/25; 725/38

(57) ABSTRACT

The display server apparatus and associated methods provide audio and video data to a plurality of displays. The apparatus and methods enable monitoring of the content being viewed on a secondary display on a primary display. A secondary display may be used to view the content being displayed on a primary display when provided with appropriate authorization information. The apparatus is further capable of scaling and sizing provided audio and video streams in accordance with the characteristics and capabilities of each remote device.

### CROSS REFERENCE TO RELATED APPLICATION

This application claims priority to and all benefits accruing from provisional applications filed in the United States Patent and Trademark Office on Apr. 25, 2008 and assigned Ser. No. 61/125,587.

### FIELD OF THE INVENTION

The invention relates to a display server apparatus and associated methods for providing audio and video data to a plurality of displays. The apparatus may be in the form of a set top box for use with multiple television displays or other viewing devices.

### BACKGROUND OF THE INVENTION

The present invention generally relates to an apparatus and methods for presenting audio and video content on a plurality of display devices using a single display server. The apparatus and methods also allow the monitoring at one device of the content displayed on one or more other devices. The methods and associated apparatus are suitable for use in a home, educational, or business environment where multiple displays are required or where monitoring of content being viewed by others is desirable.

This section is intended to introduce the reader to various aspects of art, which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Many cable, satellite, digital terrestrial, and IP-based television distribution systems require the use of a set top box at the receiving location. These devices are configured to tune the particular signals from a service provider and may contain decryption circuitry and other capabilities.

Set top boxes have generally provided the capability of driving a single directly-connected display. Early U.S. set top boxes used a coaxial connection to provide a tuned cable television channel to a television on a particular VHF channel. More recent set top boxes have provided tuned signals to a display device over composite, component, SCART, DVI, or HDMI connections. Wireless transmission of video from a connection box to a display is available in some systems, primarily to address the problems in routing cables to a wall-mounted television panel, but the set top box from the service provider is still connected via conventional cabling to the connection box.

A one-to-one relationship has traditionally existed between set top boxes and display devices. In homes or other environments with multiple displays, multiple set top boxes have been required, with each set top box directly attached to a specific display device. More recent set top boxes have included multiple tuners, but generally for the purpose of recording one program while displaying another or for displaying multiple programs in a picture-in-picture mode, not for driving multiple displays. Connections to the display device have still been through direct, short distance, video-specific cabling, with a one-to-one relationship of set top box to display.

This one-to-one arrangement produces a high degree of equipment and setup redundancy. For instance, in terms of hardware, each set top box requires its own housing, power supply, processor, tuners, decryption, storage, and front panel display and controls. With regard to setup, each set top box needs to be individually programmed with setting such as favorite channel selections, program guide preferences, and parental controls.

The one-to-one set top box relationship also limits the features that can be made available which are specifically related to the multiple display environment. While the set top boxes each receive programming from the service provider and provide signals to a display device, few set top boxes are able to communicate with each other. One exception is the multi-room digital video recorder (DVR) technology available from some service providers. With this technology, a set top box in a secondary location may access recorded content on a primary set top box.

Such systems still suffer, however, from the hardware and setup redundancy issues described above. Furthermore, these systems fail to offer the ability for a viewer at one display device to monitor the content being displayed on another display device. The invention described herein addresses this and/or other problems.

### SUMMARY OF THE INVENTION

In order to solve the problems described above, the present invention concerns an apparatus associated methods for receiving video content and providing it to multiple display devices, as well as allowing a display device to view content being provided to another display device. This and other aspects of the invention will be described in detail with reference to the accompanying Drawings.

Generally, the present invention defines a method comprising generating a first video signal comprising first program content; providing said first video signal to a first output; generating a second video signal comprising second program content; providing said second video signal to a second output; receiving user input; and responsive to receiving said user input, generating a third video signal comprising said first program content and said second program content and providing said third video signal to said first output.

In accordance with one aspect of the invention, the method further comprises the steps of, responsive to said user input, displaying a request for authorization information, receiving authorization information, and verifying said authorization information.

In accordance with another aspect of the invention, each of the first output and second output comprises one of a DVI, HDMI, DisplayPort, SCART, HD15, composite, S-video, or component video output or a wired or wireless network connection.

In accordance with another aspect of the invention, the first video signal and the second video signal further comprise associated audio signals.

In accordance with another aspect of the invention, user input is received via infrared or RF signals.

In accordance with another aspect of the invention, user input is received via a wired or wireless network.

In accordance with yet another aspect of the present invention, an apparatus is provided comprising: means for generating a first video signal comprising first program content; means for providing said first video signal to a first output; means for generating a second video signal comprising second program content; means for providing said second video signal to a second output; means for receiving user input; and means for, responsive to receiving said user input, generating a third video signal comprising said first program content and said second program content and providing said third video signal to said first output.

In accordance with still another aspect of the invention, a method is provided comprising the steps of, generating a first video signal comprising first program content, providing said first video signal to a first output, generating a second video signal comprising second program content, providing said second video signal to a second output, receiving user input indicating a request for third program content, and responsive to receiving said user input, generating a third video signal comprising third program content and providing said third video signal to said second output.

These and other aspects of the invention will be explained with reference to a preferred embodiment of the invention show in the accompanying drawings.

### BRIEF DESCRIPTION OF THE DRAWINGS

The above-mentioned and other features and advantages of this invention, and the manner of attaining them, will become more apparent, and the invention will be better understood, by reference to the following description of embodiments of the invention taken in conjunction with the accompanying drawings, wherein:

FIG. 1 is a diagram of an embodiment of a system embodying aspects of the present invention;

FIG. 2 depicts screen displays of an embodiment of the present invention;

FIG. 3 depicts screen displays of an embodiment of the present invention;

FIGS. 4a and 4b depict screen displays of an embodiment of the present invention;

FIG. 5 is a flow chart of an exemplary method according to the present invention;

FIG. 6 is a block diagram of an embodiment of the present invention.

The exemplifications set out herein illustrate preferred embodiments of the invention, and such exemplifications are not to be construed as limiting the scope of the invention in any manner.

### DETAILED DESCRIPTION OF THE DRAWINGS

As described herein, the present invention provides a display server apparatus and associated methods for receiving video content and providing it to multiple display devices, as well as for allowing a display device to also view content being provided to another display device. Such a display server may include advanced features, including multiple UI screens managed from the server with separate frame buffers, monitoring of remote displays, the ability for a remote device to login via a password and have the ability to view the content provided to a primary display, the ability to view content being provided to multiple display devices simultaneously, the ability to scale the size or resolution of content to suit the receiving device, the ability to send normal video, web pages, or encoded bit streams, and the ability to receive from the remote device remote control input, as well as input from touch screens or other devices.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

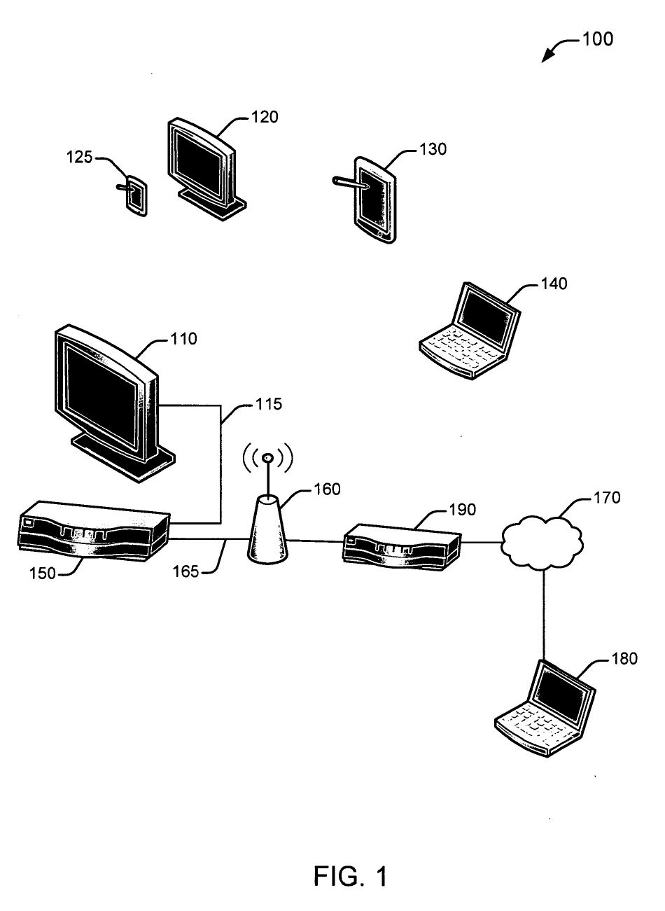

A diagram of an embodiment of a system embodying aspects of the present invention 100 is shown in FIG. 1. A display server 150 is attached to a primary display 110 via a connection 115 and to a video access point (VAP) 160 via a connection 165. Various devices may connect to the display server 150 via the VAP 160, such as a secondary display 120, a tablet device 130, or a laptop 140. Connection may also be made over the Internet 170 to a remote computing device 180. Displays may have a remote control unit 125 which may communicate through display 120, through router 190, through VAP 160, or directly to display server 150, depending on the configuration of the system.

The VAP 160 may use any of a variety of wired or wireless networking technologies. Networking technologies such as IEEE 802.11n wireless or Gigabit Ethernet may be particularly suitable due to the bandwidth requirements of high definition television. The VAP 160 functionality may be housed separately as shown or within the display server 150. In some embodiments, a primary display 110 may connect to VAP 160 rather than directly to display server 150. In some embodiments, the video content may be distributed over an existing network in the environment through a router 190. Router 190 may provide wired or wireless connectivity to the various network devices, as well as connection to the Internet 170. In some cases, VAP 160 may use a different wireless protocol for video transmission to avoid interference with a wireless network of router 190 or to avoid saturation of the local network bandwidth.

Each device 110, 120, 130, 140, 180 may obtain a different program stream from the display server 150, subject to the limitations of that device. For instance, if the display server 150 contains only two tuners, it may be limited to providing only two different live tuned programs. The display server 150 may receive program content from a variety of sources including cable, satellite, Internet, over-the-air broadcast, or internal or network storage. The display server apparatus 150 may be capable of scaling and sizing provided audio and video streams in accordance with the characteristics and capabilities of each remote device. Such scaling and sizing may be performed using dedicated image processing components or using generic computing hardware.

User input at the display server 150 location may be received directly by the display server via infrared or RF signals, including Wi-Fi or Bluetooth networking protocols. At displays remote from the display server 150, a variety of mechanisms may be used for receiving user input and providing it to the display server. In some environments, a wireless network may be available. A remote control device connected to a wireless access point on the network may communicate over the network to the display server. In other environments, infrared repeaters can be used to receive IR signals at the remote display and convey them to the display server. In yet other environments, user input devices such as remote controls may have RF transceivers that communicate directly with the display server. In other environments, the display device 120 may receive user input and transmit it back to the display server via its connection. In the case of a display device 130 with tablet or touch screen capability, screen input may be provided back to display server 150 to control its function.

A user at a remote display device may be provided with user interface functionality similar to that provided with a directly connected set top box. For instance, a remote control device used at a secondary display 120 may contain “guide,” navigation, and channel change buttons. Additionally, display server 150 may also provide web or Internet access to a user via display 120, with remote 125 used to provide user input.

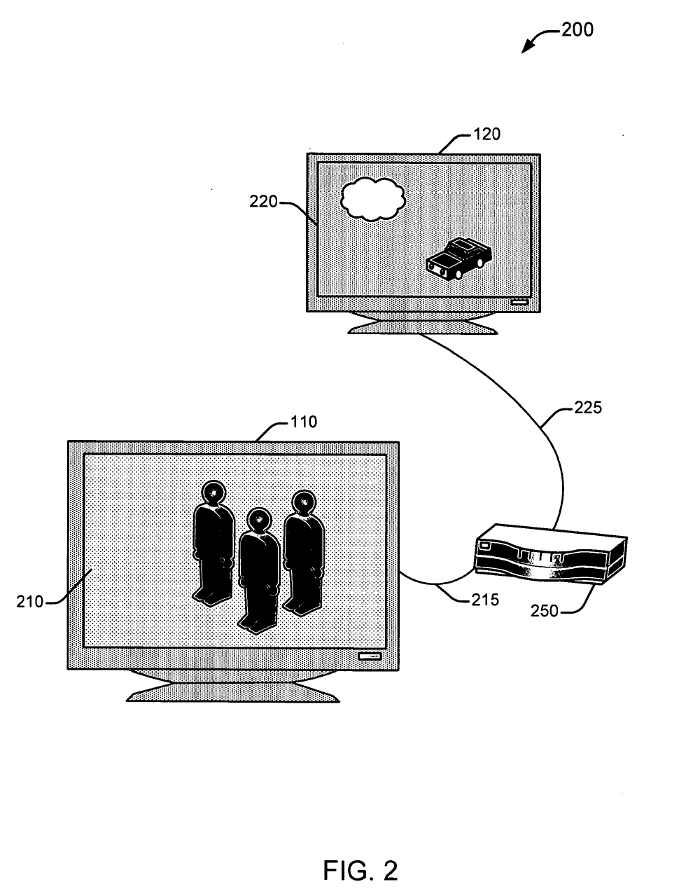

FIG. 2 depicts screen displays of an embodiment of the present invention. In some embodiments, the primary display device 110 could be a television in the living room of a residence and the secondary display device 120 could be a television in another room. A display server 250 with internal VAP functionality is connected to primary display 110 via connection 215 and to secondary display 120 via a connection 225. Connections 215 and connection 225 could be one of a DVI, HDMI, DisplayPort, SCART, HD15, composite, S-video, or component video output or a wired or wireless network connection, or other data transmission system capable of carrying the data of interest.

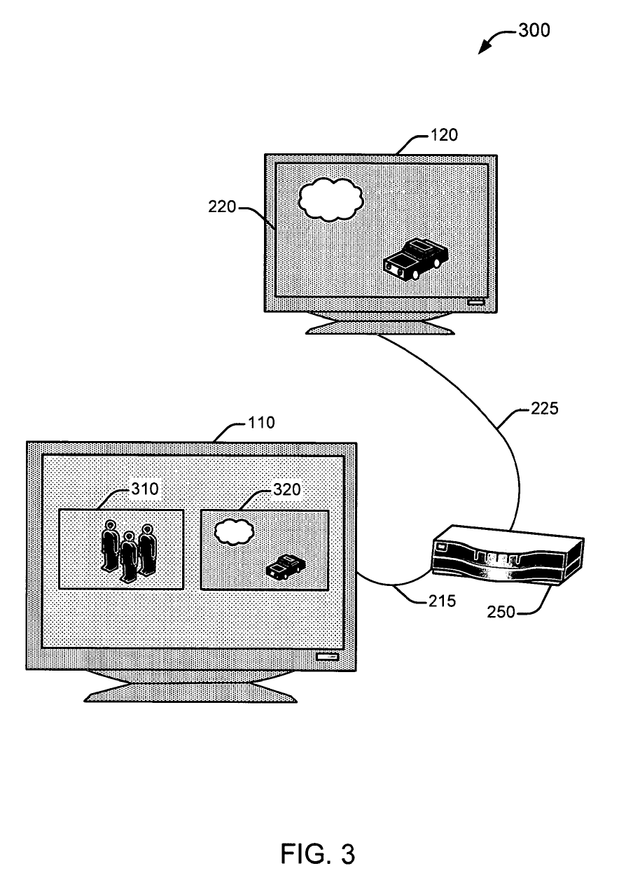

The viewer of the primary display device displaying program stream 210 may have a desire to also monitor the content 220 being viewed on the secondary display. Upon receipt of a user command, primary display 110 displays both a reduced size version of the primary program stream 310 and of the secondary program stream 320, as shown in FIG. 3. Secondary display 120 continues to display the secondary program stream 220. The secondary program stream 220 could also be displayed as a picture-in-picture within the primary program display 210, as a transparent overlay, or in an auxiliary display associated with the primary display device 110. The secondary display device 120 may or may not provide an indication to the viewer that the viewed content is being monitored at another display.

In some embodiments, the primary display 110 may have default permission to view program streams associated with other display devices. A secondary device 120 may be configured to require a password or other authorization before allowing viewing of program content being provided to other devices, such as primary display 110.

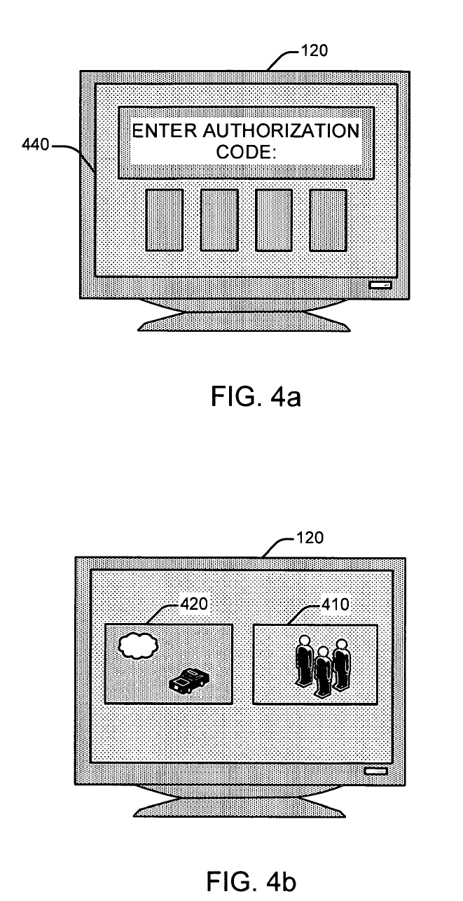

FIG. 4a depicts a screen display of an embodiment of the present invention after a user of secondary device 120 has made a request to also view program content being provided to primary display device 110. The user is presented an authorization screen 440. An authorization screen 440 may request an alphanumeric password, instruct a user to insert an authorization device, or perform some other authentication activity. FIG. 4b illustrates the secondary display 120 after appropriate authorization credentials have been supplied. A reduced size version 420 of the program originally displayed on the secondary display 120 and a reduced size version 410 of the program displayed on the primary display are shown simultaneously. The content may also be displayed as picture-in-picture, overlay, or other combinations.

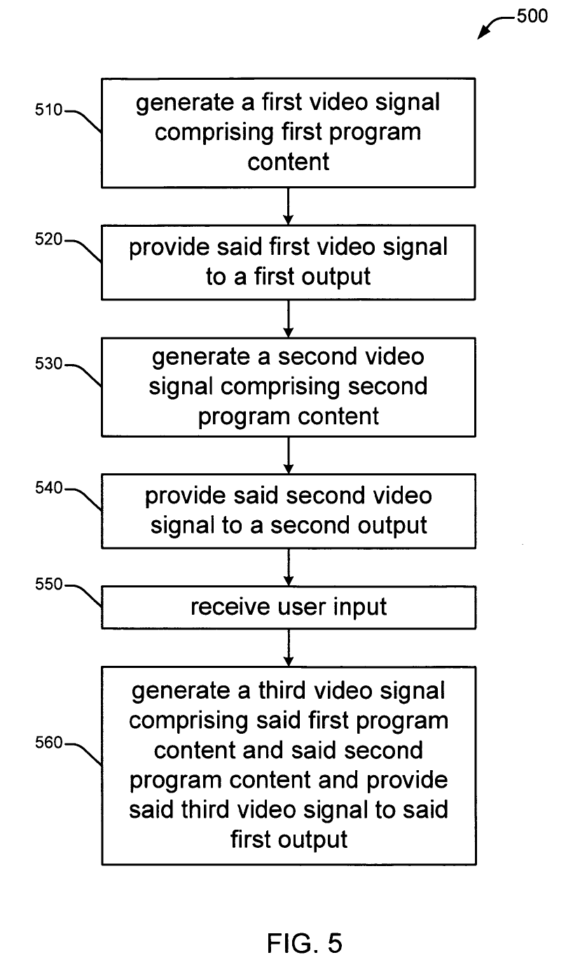

FIG. 5 is a flowchart of a method 500 of the present invention. The method comprises generating a first video signal comprising first program content 510; providing said first video signal to a first output 520; generating a second video signal comprising second program content 530; providing said second video signal to a second output 540; receiving user input 550; and responsive to receiving user input requesting monitoring of another display, generating a third video signal comprising said first program content and said second program content and providing said third video signal to said first output 560.

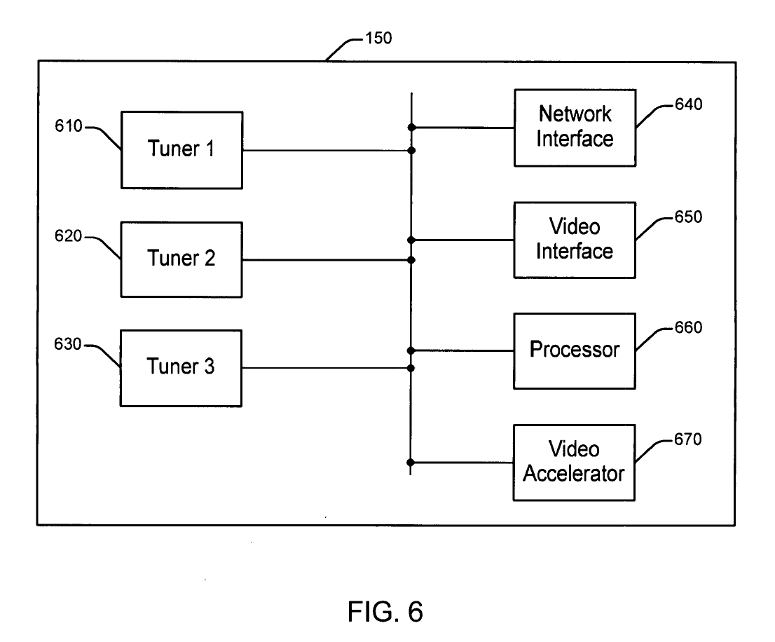

FIG. 6 is a block diagram of an embodiment of a display server 150. The display server may contain one or more tuners 610, 620, 630 for tuning content streams from cable, satellite or other sources. The network interface 640 may be used to obtain content from a network, to communicate with display devices, and to receive user input, among other functions. A processor 660 coordinates the operation of the components of the system. More than one processor may be used in some embodiments. A video accelerator 670 provides video co-processing to reduce demands on the processor 660. The video accelerator 660 may provide scaling, resizing, decompression, compression or other functions. In some embodiments, the capabilities of the processor 660 may reduce or eliminate the need for a video accelerator 670. In other embodiments, multiple video accelerators 670 may be used to provide more advanced video processing or to provide video processing for multiple display devices. Each video accelerator 670 may contain frame buffer circuitry for the generation and storage of video data destined for a display. In other embodiments, compressed video data may be provided to a remote display, which would in turn decompress the data into local frame buffer storage.

While the present invention has been described in terms of a specific embodiment, it will be appreciated that modifications may be made which will fall within the scope of the invention. For example, various processing steps may be implemented separately or combined, and may be implemented in general purpose or dedicated data processing hardware.

1. A method comprising the steps of:
generating a first video signal comprising first program content;
providing said first video signal to a first output;
generating a second video signal comprising second program content;
providing said second video signal to a second output;
receiving user input; and
responsive to receiving said user input, generating a third video signal comprising said first program content and said second program content and providing said third video signal to said first output.

2. The method of claim 1 comprising the further steps of:
responsive to said user input:
displaying a request for authorization information;
receiving authorization information; and
verifying said authorization information.

3. The method of claim 1 wherein each of said first output and said second output comprises one of a DVI, HDMI, DisplayPort, SCART, HD15, composite, S-video, or component video output or a wired or wireless network connection.

4. The method of claim 1 wherein said first video signal and said second video signal further comprise associated audio signals.

5. The method of claim 1 wherein said user input is received via infrared or RF signals.

6. The method of claim 1 wherein said user input is received via a network.

7. An apparatus comprising:
means for generating a first video signal comprising first program content;
means for providing said first video signal to a first output;
means for generating a second video signal comprising second program content;
means for providing said second video signal to a second output;
means for receiving user input; and
means for, responsive to receiving said user input, generating a third video signal comprising said first program content and said second program content and providing said third video signal to said first output.

8. The apparatus of claim 7 comprising the further steps of:
responsive to said user input:
displaying a request for authorization information;
receiving authorization information; and
verifying said authorization information.

9. The apparatus of claim 7 wherein each of said first output and said second output comprises one of a DVI, HDMI, DisplayPort, SCART, HD15, composite, S-video, or component video output or a wired or wireless network connection.

10. The apparatus of claim 7 wherein said first video signal and said second video signal further comprise associated audio signals.

11. The apparatus of claim 7 wherein said user input is received via infrared or RF signals.

12. The apparatus of claim 7 wherein said user input is received via a network.

13. A method comprising the steps of:
generating a first video signal comprising first program content;
providing said first video signal to a first output;
generating a second video signal comprising second program content;
providing said second video signal to a second output;
receiving user input indicating a request for third program content; and
responsive to receiving said user input, generating a third video signal comprising third program content and providing said third video signal to said second output.

14. The apparatus of claim 13 wherein said generating a third video signal further comprises:
generating graphical content relevant to said third program content; and
combining said graphical content with said third program content.

15. The apparatus of claim 13 wherein each of said first output and said second output comprises one of a DVI, HDMI, DisplayPort, SCART, HD15, composite, S-video, or component video output or a wired or wireless network connection.

16. The apparatus of claim 13 wherein said first video signal and said second video signal further comprise associated audio signals.

17. The apparatus of claim 13 wherein said user input is received via infrared or RF signals.

18. The apparatus of claim 13 wherein said user input is received via a network.
